(19) United States
(12) Patent Application Publication
(10) Pub. No.: US 2014/0226319 A1
(43) Pub. Date: Aug. 14, 2014

(54) Tactical Throw Light

(71) Applicant: Christopher Howell, St. Croix, VI (US)

(72) Inventor: Christopher Howell, St. Croix, VI (US)

(21) Appl. No.: 13/762,898

(22) Filed: Feb. 8, 2013

(51) Int. Cl. F21L 4/04

(52) U.S. Cl. CPC F21L 15/02
USPC 362/200

(57) ABSTRACT

An automatic tactical light bar includes a body having a plurality of illuminated sides including at least a first illuminated side and a second illuminated side arranged around a central chamber; a plurality of illumination elements fixed to the illuminated sides with at least one illumination element per illuminated side; an electric circuit in communication with the illumination elements and the central chamber, the circuit including at least one orientation sensor; an electric power source in the central chamber and in communication with the plurality of illumination elements through the electric circuit, wherein the at least one orientation sensor controls one of plurality of illumination elements according to the electric circuit, wherein each of the at least one orientation sensors are arranged inside the body to selectively supply power to the at least one illumination elements corresponding to the first illuminated side.

### PRIORITY

Not Applicable

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to a tactical light and, more particularly, to a tactical throw light having a plurality of illumination elements around its circumference to selectively and automatically provide a safe light source in a dangerous or potentially dangerous tactical situation.

### BACKGROUND OF THE INVENTION

Prior-art tactical lights present a hazard to its users. The hazard lies in that the tactical lights are hand-held or weapon-mounted. Both of these conditions clearly and unambiguously announce your exact location to everyone. In a truly tactical situation the light, and the person holding the light, are a target. However, one cannot simply throw his flashlight into a dark room and expect it to shine in a useful direction.

Conventional weapon mounted flashlights as well as handheld flashlights are very directional instruments. This means that they are only effective in a narrow field in the direction in which they are aimed. This puts tactical officers at a distinct disadvantage if their conventional lights (and the officers' attention) are focused on one area of the room and there's activity in the opposite corner. An officer in a well-lit room would prefer to have better use of his or her peripheral vision. A better tactical light is needed.

### SUMMARY OF THE INVENTION

The tactical throw light provides superior utility and advantages as it provides a high volume of non-unidirectional light which effectively illuminates an entire room rather than only a small area. The tactical throw light does so automatically without being handheld.

A tactical throw light (or tactical light bar) may be used safely in situations where a conventional handheld or weapon-mounted light would be dangerous. An automatic, selective application of light is tremendously helpful and reduces the risk associated with facing potentially aggressive or violent people in dark rooms and buildings, and in other situations where it is not practical to carry a light. The present invention has the following key features, functions, and benefits:
Throwable light for those times when a hand-held or weapon-mounted light is inappropriate
Automatic illumination in the correct direction, no matter how the thrown light lands and comes to rest
Rugged construction including LED illumination and incorporated shock absorbing materials
Delayed power-on feature to permit the tactical light to be thrown into position before the light is powered on
Automatic power-off in holster and power-on when removed from holster

In a first embodiment, an automatic tactical light bar includes:
a body having a plurality of illuminated sides including at least a first illuminated side and a second illuminated side arranged around a central chamber;
a plurality of illumination elements fixed to the illuminated sides with at least one illumination element per illuminated side;
an electric circuit in communication with the illumination elements and the central chamber, the circuit including at least one orientation sensor;
an electric power source in the central chamber and in communication with the plurality of illumination elements through the electric circuit,
wherein the at least one orientation sensor controls one of plurality of illumination elements according to the electric circuit,
wherein each of the at least one orientation sensors are arranged inside the body to selectively supply power to the at least one illumination elements corresponding to the first illuminated side.

This provides the advantage of a tactical light bar which is very easy to deploy. The light bar is arranged so that only those light elements corresponding to a particular orientation, e.g., away from the ground, or generally upward, are powered to provide illumination. Thus no matter how the light bar is thrown or tossed into a room or an area, the appropriate predetermined light elements are powered and the most useful light conditions are enabled.

According to a first variation, the at least one illumination elements corresponding to the first illuminated side are illuminated when the body is at rest on the second illuminated side. This provides an advantage in that only those sides which are not resting on or against the ground may be powered to provide illumination.

According to a further variation, the at least one illumination element corresponding to the first illuminated side is selectively powered dependent upon the orientation sensor and the orientation of each of the plurality of illuminated sides relative to a vertical axis. This provides an advantage in that only those illuminated sides having the proper orientation are able to be powered.

According to another variation, the at least one illumination element corresponding to the first illuminated side is powered when the first illuminated side is oriented above all other illuminated sides, according to the vertical axis, wherein only a single illuminated side is powered at a time. This provides an advantage in that only the uppermost illuminated side is powered. This ensures that the light will most likely be pointed in a direction which will provide a useful illumination, such as through reflecting from a ceiling, and further makes it more likely that the illumination will not shine in the eyes of the light bar's user(s).

According to another variation, the at least one illumination element corresponding to two or more of the plurality of illuminated sides are powered when the two or more of the plurality of illuminated sides is oriented above any other illuminated side, according to the vertical axis. This provides an advantage in that the illumination is not limited to a single illuminated side. More useful light is provided when more light elements and illuminated sides are powered. This variation may be particularly helpful and useful when there are a great number of illuminated sides, such as five or more.

According to a further variation, the body includes an even number of illuminated sides. In such an arrangement, the illuminated sides may be arranged in a regular manner around the body so as to form a regular polygon, when viewed in section. However, the device is not so limited and may include irregularly sized and spaced illuminated sides. One advantage of an even number of sides is that there is positively be an illuminated side which is higher than all others. Thus the determination of the top or highest illuminated side is derived easily.

According to another variation, the body includes an odd number of illuminated sides. In such an arrangement, the illuminated sides may be arranged in a regular manner around the body so as to form a regular polygon when viewed in section. However, the device is not so limited and may include irregularly sized and spaced illuminated sides. One advantage of an odd number of sides is that there are positively two illuminated side which are higher than all others. Thus the determination of the top two or highest two illuminated sides is derived easily. This is particularly useful where it is desired to have multiple illuminated sides powered upwardly at the same time. This condition is addressed in the next paragraph.

According to a further variation, the at least one illumination elements corresponding to the first illuminated side and the second illuminated side are powered when the first illuminated side and second illuminated side are oriented above all other illuminated sides, according to the vertical axis, wherein only the top two illuminated sides are powered at a time.

According to another variation, the tactical light bar further includes a delay timer, wherein the electric circuit of the tactical light bar is not powered until a predetermined time period has elapsed. An advantage of a delay function is that the user has an opportunity to deploy the tactical light bar before any of the illumination elements of the illuminated sides are powered. This provides an addition measure of safety for the user, wherein a person who may be in the illuminated area will not be able to determine the original of the light bar. The light bar would be thrown or deployed while extinguished and would provide illumination only after it has come to rest or after a predetermined time period.

According to a further variation, the tactical light bar further includes a sheath, wherein insertion of the tactical light bar into the sheath deactivates the tactical light bar, and removal from the sheath activates the tactical light bar. This provides an advantage in that the tactical light bar may be perpetually ready for deployment within the sheath and ready to be automatically activated and energized upon removal from the sheath. A magnetically-operated reed switch or similar arrangement may be used to prevent activation of the tactical light bar within the sheath. A sheath may include a belt-worn unit or may be a pocket or holster or other type of container.

According to another variation, the tactical light bar further includes a manual power switch for manually activating and deactivating the tactical light bar. Such a feature permits the light bar to be used without a sheath. This feature may be combined with the delay function described above.

According to another variation, the body further comprises generally planar illuminated sides which are longer in a longitudinal direction than in a coplanar direction which is normal to the longitudinal direction. The relatively elongated sides act to ensure that the light bar will be very unlikely to come to rest on an end face, which is significantly smaller. The end faces may be radiused or curved to further reduce the likelihood of the light bar coming to rest on an end face.

According to a further variation, the body further includes a pair of end faces which are generally normal to each of the illuminated sides. However, as described in the preceding paragraph, the end faces may include a radius feature or curve between the end face and each of the illuminated sides to encourage the light bar to come to rest on one of the illuminated sides. Each of the end faces may include an area (face area) smaller than the area of each of the illuminated sides.

According to another variation, the orientation sensor includes at least one gravity-sensitive electric switch, e.g., a MEMS switch, mercury switch. Such switches are advantageously inexpensive, which would permit multiple switches to be included in each electric circuit. Additionally or in the alternative, multiple electric circuits having one or more gravity-sensitive switches may be incorporated into the tactical light bar. Such redundancy would create a more failsafe arrangement, and would ensure proper operation of some or all of the predetermined illumination elements of the predetermined/desired illumination face(s) even if one of the switches were to fail or get ‘stuck’ in an ‘off’ phase.

According to a further variation, the orientation sensor comprises at least one proximity sensor. The proximity sensor provides an advantage in that it does not rely strictly on an ‘up’ or ‘down’ determination, but determines which illuminated side is facing the ground due to the proximity of the ground. The opposite side of the tactical light bar and the associated orientation sensor would perceive no such proximity condition. A tactical light bar having proximity sensors may illuminate a predetermined illuminated side according to the lack of a proximity condition, which would be true for the upper illuminated sides. In the alternative, the proximity sensors may be used to determine which side is closest to the ground and to use this information to provide power to the opposite illuminated side.

According to another variation, the illuminated sides of the tactical light bar may be of a generally flat, planar arrangement or, in the alternative, the illuminated sides may be curved. Where the illuminated sides are generally flat, the flat faces provide a more aggressive surface for stopping the tactical light bar from rolling too far, and to keep the light bar in a position once it has stopped rolling, tumbling or sliding.

According to a further variation, the tactical light bar includes one or more wireless receivers in communication with the electric circuit. The wireless receivers provide the ability to receive a wireless signal, such as RF or IR signals, for manually controlling which illuminated sides of the tactical light bar are powered. This arrangement provides an advantage in the instances where one or more of the powered illuminated sides is a distraction or a hazard. The wireless controller may be a dedicated controller, or may be a smartphone application. The controller allows the illumination elements to be selectively, manually controlled. As another variation of this, the tactical light bar may be programmed so that all of the illumination elements are powered at first, only to be selectively shut down after deployment.

According to a second embodiment, an automatic tactical light bar comprises:
a body having a plurality of illuminated sides arranged around a central chamber;
a plurality of illumination elements fixed to the illuminated sides with at least a first illumination element and a second illumination element per each illuminated side;
a first electric circuit in communication with the first illumination element on each illuminated side and the central chamber, the circuit including at least one orientation sensor;
a second electric circuit in communication with the second illumination element on each illuminated side and the central chamber, the circuit including at least one orientation switch;
an electric power source in the central chamber and in communication with the plurality of illumination elements through the first and second electric circuits, wherein the number of orientation sensors is equal to the number of illuminated sides,
wherein each orientation sensor of the first electric circuit controls the first illumination elements for each illuminated side,
wherein each orientation sensor of the second circuit controls the second illumination elements for each illuminated side,
wherein the first and second electric circuits and orientation sensors are arranged inside the body and selectively supply power to the first and second illumination elements corresponding to a first illuminated side when the body is at rest on a second illuminated side.

This arrangement is similar to the first embodiment described above, except that the second embodiment of the tactical light bar includes a second illumination element on each illuminated face, and a second electric circuit for controlling the second illumination element on each face. This arrangement yields a light bar which is more failsafe in operation than the first embodiment, and provides more positive control no matter if a single electric circuit, orientation switch or illumination element should fail. This embodiment may be adapted to use each of the variations described above for the first embodiment.

According to a first variation of the second embodiment, the first and second illumination elements of each illuminated side are selectively powered dependent upon their orientation relative to a vertical axis corresponding to gravity. This variation provides an advantage in that twice the number of illumination elements will be powered, but that each of the illumination elements will be powered through a separate electrical circuit.

According to a third embodiment, an automatic tactical light bar includes:
a body having a plurality of illuminated sides arranged around a central chamber;
a plurality of illumination elements fixed to the illuminated sides with at least one illumination element per each of the illuminated sides;
an electric circuit in communication with the illumination elements and the central chamber, the circuit including a plurality of orientation sensors;
an electric power source in the central chamber and in communication with the illumination elements through the electric circuit, wherein the number of orientation sensors is less than the number of illuminated sides,
wherein each orientation sensor controls illumination elements corresponding to at least one illuminated side,
wherein each of the orientation sensors are arranged inside the body to selectively supply power to predetermined illumination elements corresponding to the orientation of a first predetermined illuminated side when the body is at rest on a second predetermined illuminated side.

The third embodiment provides several advantages including that fewer orientation switches are required. This is possible where a single orientation switch is used to control, for example, illuminated sides which are on opposite sides of the body or illuminated sides which are adjacent to each other. A single orientation switch may be used to determine which side is ‘up’ and therefore when the opposite side is ‘down’. In addition, or in the alternative, orientation signals from a single switch may be used to control the entire electric circuit and all of the illumination elements for each illuminated side. In the alternative, orientation signals from two or more orientation switches may be combined to determine ‘up’ and ‘down’ for each of the illuminated sides. Like the second embodiment, the third embodiment may be adapted to use each of the variations described above for the first embodiment.

According to a first variation of the third embodiment, the at least one illumination element of each illuminated side is selectively powered dependent upon its orientation relative to a vertical axis. The vertical axis corresponds to gravity.

Numerous other features, elements and characteristics may be included in each of the tactical light bars described above.

The tactical light bar may include illumination elements for one or more select spectra, including infrared, visible and ultraviolet. While the visible spectrum provides advantages to the user in dark conditions, the infrared (IR) version may be used in any light condition, and may be used as a marker for aircraft or others.

LED illumination elements are tough and durable, but the tactical light bar is expected to suffer from abuse during it normal operation. Therefore, the light bar may include an impact-resistant housing. This housing may be made of metal, for example, and may double as a heat sink for the illumination elements (light sources). Other materials or combinations of materials, i.e., high-strength plastics and rubbers, may be used as well to mitigate damage to the tactical light bar itself and whatever the unit impacts.

The tactical light bar may include different modes of light display, including a steady on display, and numerous blinking-type displaces, including a strobe-type effect which may tend to somewhat disable humans or reduce their cognitive abilities. Additionally, it is expected that the illumination elements will be relatively high-powered to provide effective illumination in a tactical situation. 700+ lumens are a typical value at this time, but the illumination elements may be significantly more powerful with an appropriate heat control arrangement. The Infrared illumination elements may be powerful enough to be seen with NVGs (Night Vision Goggles). Acceptable illumination elements may include LEDs, incandescent bulbs, strobe units and other devices.

More light is better, but also creates a heat problem. This is why the body may include a large heat sink capability. It is not expected that the light would need to operate for hours continuously, but heat buildup may reduce the illumination output and the lifespan of the illumination elements.

The illumination elements of each illuminated side of the tactical light bar may be arranged in a variety of manners on the body, to include a flush-mount, wherein the illumination elements are even with the surface of the body and the illuminated sides. For additional protection, the illumination elements may be inset (recessed) slightly below the plane of the external surface of the illuminated sides to provide more protection from most hazards likely to be encountered. In addition, lenses may be attached above the illumination elements to diffuse and/or spread light as well as to protect the illumination elements from damage during impact.

### BRIEF DESCRIPTION OF THE DRAWINGS

FIG. 1 illustrates a schematic view of a tactical light bar, according to the present invention;

FIG. 2 illustrates a perspective view of a tactical light bar, minus the caps over the end faces;

FIG. 3 illustrates a sectional view of a central channel and central cavity for a tactical light bar;

FIG. 4 illustrates a side view of an illumination element arrangement for a tactical light bar;

FIGS. 5-6 illustrate end views of a tactical light bars having two illuminated sides.

FIGS. 7A-7F illustrate sectional side view of various polygonal arrangements for tactical light bars.

### DETAILED DESCRIPTION OF THE INVENTION

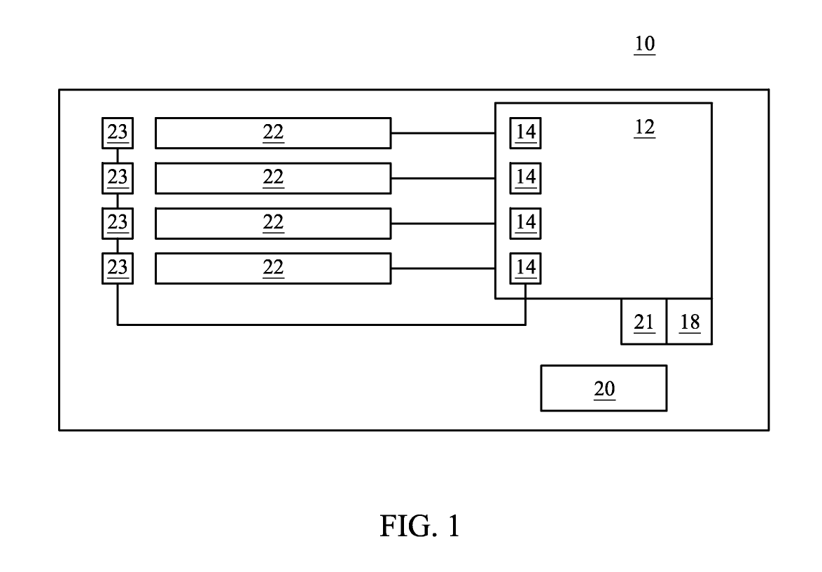

The invention will now be explained with reference to a tactical light bar. Referring now to the drawings and, more particularly, to FIG. 1 thereof, there is shown a schematic drawing of an exemplary arrangement for a tactical light bar 10. FIG. 1 illustrates a schematic diagram for a tactical light bar having an electric circuit 12 with four (4) orientation sensors 14, which may be incorporated into the tactical light bar 10 illustrated in FIG. 2, which has four (4) illuminated sides 16. The electric circuit 12 may include a switch 18 such as a reed switch to remove power to the circuit in a holster or other device having a similar function. A battery 20, which may be a single battery or a plurality of batteries supply power to the circuit and to the illumination elements 22 for each of the illuminated sides 16. Power is selectively applied to the LEDs in a predetermined manner, depending upon the conditions of the orientation sensors 14, which may be tilt switches or proximity sensors. Only one LED is shown in FIG. 1, but any number of LEDs may be incorporated into the tactical light bar 10, as illustrated in FIG. 2. Non-LEDs are able to be used as well, according to the light desired and the power which is able to be provided. A timer 21 delays the application of power to the electric circuit or the illumination elements until a predetermined time period has elapsed.

FIG. 2 illustrates a perspective view of a tactical light bar 10, with the caps over the end faces 24 removed for clarity. FIG. 2 illustrates one possible construction method for a tactical light bar 10. A central chamber 26 provides a cavity for the battery or batteries 20 and electric circuit 12. The tactical light bar 10 may include more than one electric circuit 12 to power multiple arrays of illumination elements 22 independently, in a failsafe arrangement.

In the exemplary tactical light bar of FIG. 2, the central chamber 26 is formed in a central channel 28 having a general square cross section. Other shapes may be used according to the teachings herein, including triangular, pentagonal and other polygonal arrangements. A number of outer panels 30 consisting of L-shaped channels in FIG. 2, are attached, such as with bolts and screws, to the central channel 28. The central channel 28 and the outer panels 30 may be, for example, metal or high-strength plastics. It is preferred that the materials used for the outer panels in particular have sufficient heat sink properties to control the heat generated by the illumination elements 22.

The central channel 28 and the outer panels 30 may be separated, for example, by shock-absorbing materials 32 to aid in mitigating the likelihood of damage when the tactical light bar 10 is thrown, tossed or slid into position. As illustrated in FIG. 2, the illumination elements 22 are attached to the outer panels 30 so as to be generally flush with, or even with, the surface of the outer panels 30, but different arrangements may be preferred.

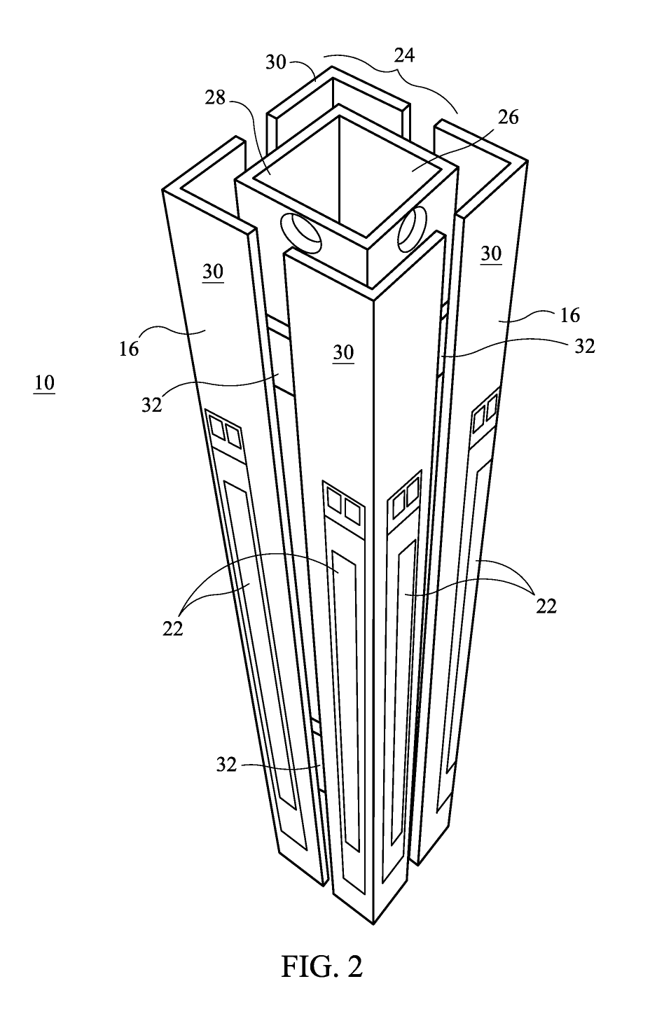

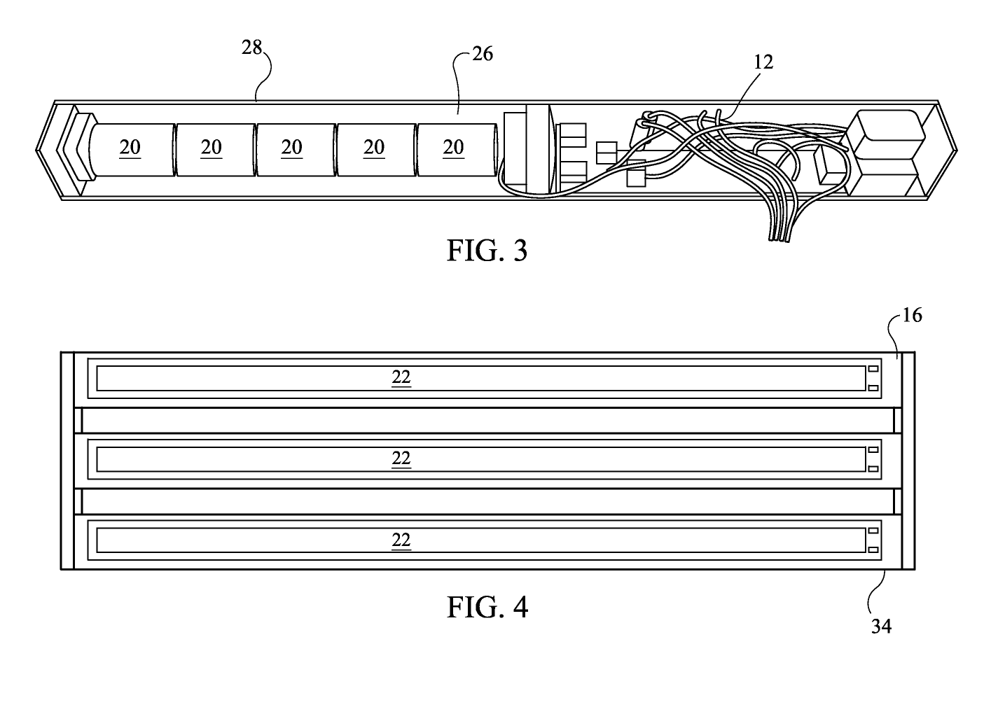

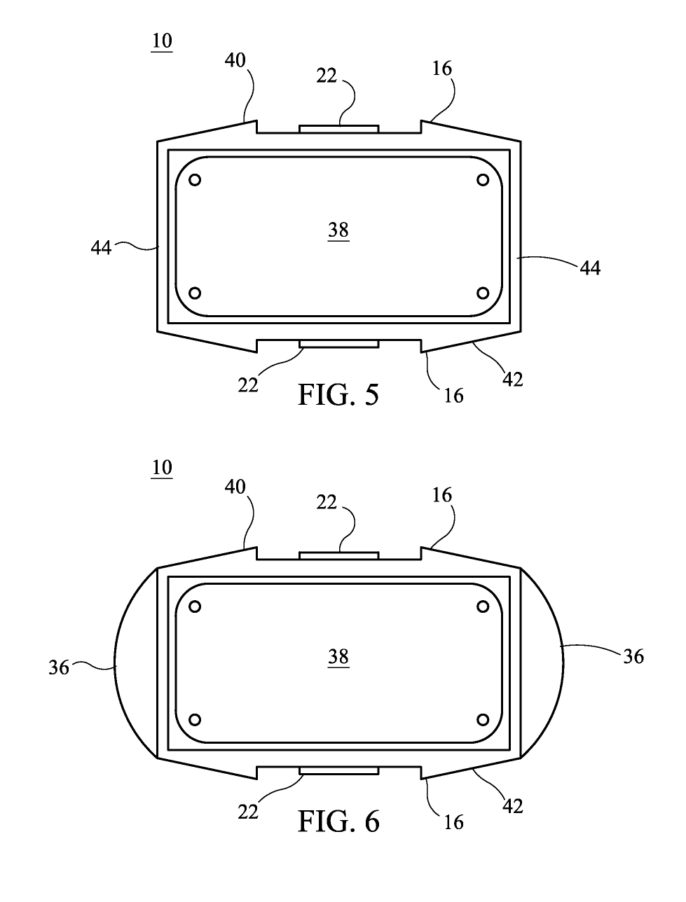

FIG. 3 illustrates a sectional view of a central channel 28 and central cavity 26 for a tactical light bar 10. The central cavity 26 may be compartmentalized, as illustrated, to provide a designated space for batteries 20 and for the electric circuit 12. FIG. 4 illustrates a side view of a three illumination element 22 arrangement for a tactical light bar 10. Unlike the arrangement of FIG. 2, wherein the outer panels 30 are arranged at the corners of the central channel 28, FIG. 4 illustrates an outer panel 34 that may be attached across a planar face of the central channel 28. Three illuminated elements 22 are shown attached to the outer panel 34, and each of the illumination elements 22 may be controlled by a single electric circuit 12, or each illumination element 22 may be controlled independently by separate electric circuits 12. FIGS. 5-6 illustrate end views of tactical light bars 10 having only two illuminated sides 16, a first illuminated side 40 and a second illuminated side 42. The tactical light bar 10 of FIG. 5 illustrates an embodiment that is inexpensive to build, but includes a pair of generally flat side faces 44 which are about half the area of the illuminated sides 16, 40, 42. The broad side faces 44 create the great potential for the tactical light bar 10 to come to rest on one of the side faces 44. This is not desirable, and would render the device ineffective. However, the device must provide sufficient space for the batteries 20, and so cannot be made very thin. The solution is illustrated in FIG. 6 where the flat side faces 44 of FIG. 5 are obscured under a rounded roll faces 36. The roll faces 36 prevent the tactical light bar 10 from coming to rest on any side but the first illuminated side 40 or the second illuminated side 42.

According to the principles of operation of the tactical light bar 10, the first illuminated side 40 will be powered when the second illuminated side 42 is against the ground. The orientation sensor(s) 14 determine which illuminated side 16 is up (corresponding to first illuminated side 40) and applies power only to that side. The remaining illuminated sides 16 are not powered. However, if the tactical light bar is rolled over to the next illuminated side 16, power will be removed from the illuminated side previously powered, and power will be applied to a new upper face. Notice also that the illumination elements 22 of FIGS. 5-6 are recessed slightly in the illuminated faces 16 to protect the illumination elements 22 from direct impact.

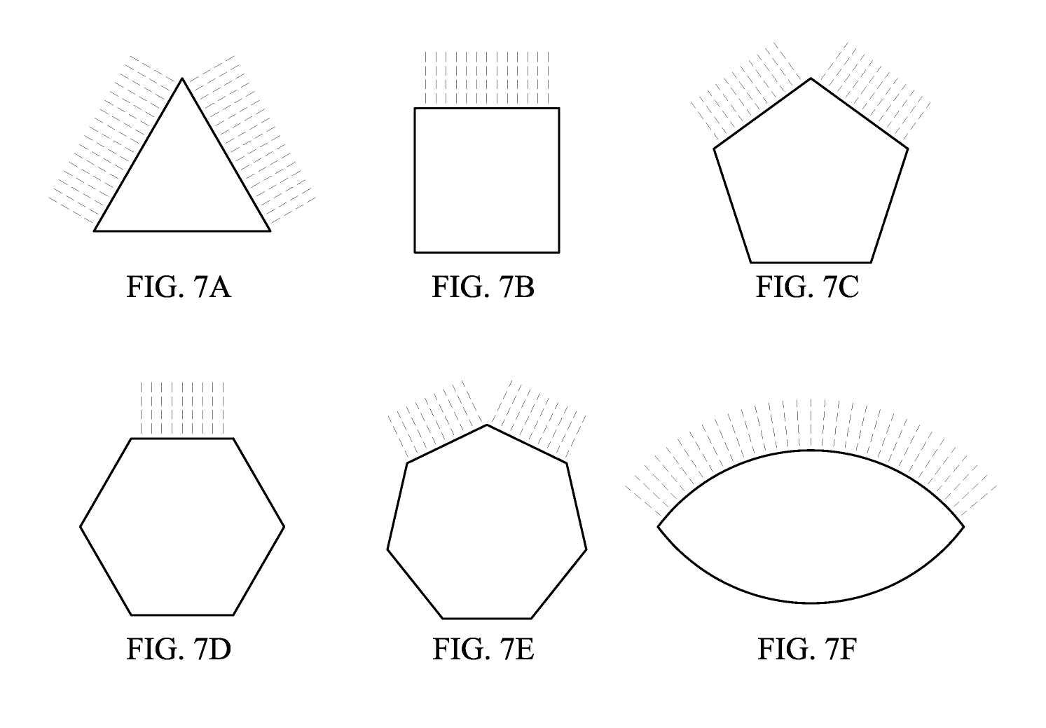

As a general principle, the illuminated sides 16 which are powered at any one time will be one or more, but will be generally symmetric. FIGS. 7A-7F illustrate sectional views of several polygonal arrangements. These are intended to be exemplary and not limiting. FIG. 7A illustrates a triangular arrangement where both of the sides which are not against the ground are powered. FIG. 7B illustrates a four-sided arrangement where only the top-most face is powered. FIG. 7C illustrates a pentagonal arrangement where the two top-most faces are powered. FIG. 7D illustrates a hexagonal arrangement where the illustrated embodiment powers only the top-most face, but in another embodiment, the sides immediately adjacent the top-most side may be powered. FIG. 7E illustrates a heptagon arrangement which is somewhat similar to the pentagonal arrangement in that the top two sides are powered. FIG. 7F illustrates a two-sided tactical light bar where the sectional view resembles a football. In this arrangement, the tactical light bar must come to rest on one of the two sides: it cannot get ‘stuck’ in a position where it will not work.

A goal in providing sufficient illumination for tactical purposes is to avoid illuminating your own position. According to this principle, it is preferred that most of the light is emitted upwardly, as illustrated.

What is claimed is:

1. An automatic tactical light bar comprises:
a body having a plurality of illuminated sides including at least a first illuminated side and a second illuminated side arranged around a central chamber;
a plurality of illumination elements fixed to the illuminated sides with at least one illumination element per illuminated side;
an electric circuit in communication with the illumination elements and the central chamber, the circuit including at least one orientation sensor;
an electric power source in the central chamber and in communication with the plurality of illumination elements through the electric circuit,
wherein the at least one orientation sensor controls one of plurality of illumination elements according to the electric circuit,
wherein each of the at least one orientation sensors are arranged inside the body to selectively supply power to the at least one illumination elements corresponding to the first illuminated side.

2. The tactical light bar of claim 1, wherein the at least one illumination elements corresponding to the first illuminated side are illuminated when the body is at rest on the second illuminated side.

3. The tactical light bar of claim 1, wherein the at least one illumination element corresponding to the first illuminated side is selectively powered dependent upon the orientation sensor and the orientation of each of the plurality of illuminated sides relative to a vertical axis.

4. The tactical light bar of claim 3, wherein the at least one illumination element corresponding to the first illuminated side is powered when the first illuminated side is oriented above all other illuminated sides, according to the vertical axis, wherein only a single illuminated side is powered at a time.

5. The tactical light bar of claim 3, wherein the at least one illumination element corresponding to two or more of the plurality of illuminated sides are powered when the two or more of the plurality of illuminated sides is oriented above any other illuminated side, according to the vertical axis.

6. The tactical light bar of claim 1, wherein the body includes an even number of illuminated sides.

7. The tactical light bar of claim 1, wherein the body includes an odd number of illuminated sides.

8. The tactical light bar of claim 7, wherein the at least one illumination elements corresponding to the first illuminated side and the second illuminated side are powered when the first illuminated side and second illuminated side are oriented above all other illuminated sides, according to the vertical axis, wherein only the top two illuminated sides are powered at a time.

9. The tactical light bar of claim 1, further comprising a delay timer, wherein electric circuit of the tactical light bar is not powered until a predetermined time period has elapsed.

10. The tactical light bar of claim 9, further comprising a sheath, wherein insertion of the tactical light bar into the sheath deactivates the tactical light bar, and removal from the sheath activates the tactical light bar.

11. The tactical light bar of claim 1, further comprising a manual power switch for manually activating and deactivating the tactical light bar.

12. The tactical light bar of claim 1, wherein the body further comprises generally planar illuminated sides which are longer in a longitudinal direction than in a coplanar direction which is normal to the longitudinal direction.

13. The tactical light bar of claim 12, wherein the body further comprises a pair of end faces which are generally normal to each of the illuminated sides.

14. The tactical light bar of claim 13, wherein each of the end faces comprise an area smaller than the area of each of the illuminates sides.

15. The tactical light bar of claim 1, wherein the orientation sensor comprises at least one gravity-sensitive electric switch.

16. The tactical light bar of claim 1, wherein the orientation sensor comprises at least one proximity sensor.

17. An automatic tactical light bar comprises:
a body having a plurality of general planar illuminated sides arranged around a central chamber;
a plurality of illumination elements fixed to the illuminated sides with at least a first illumination element and a second illumination element per each illuminated side;
a first electric circuit in communication with the first illumination element on each illuminated side and the central chamber, the circuit including at least one orientation sensor;
a second electric circuit in communication with the second illumination element on each illuminated side and the central chamber, the circuit including at least one orientation switch;
an electric power source in the central chamber and in communication with the plurality of illumination elements through the first and second electric circuits, wherein the number of orientation sensors is equal to the number of illuminated sides,
wherein each orientation sensor of the first electric circuit controls the first illumination elements for each illuminated side,
wherein each orientation sensor of the second circuit controls the second illumination elements for each illuminated side,
wherein the first and second electric circuits and orientation sensors are arranged inside the body and selectively supply power to the first and second illumination elements corresponding to a first illuminated side when the body is at rest on a second illuminated side.

18. The tactical light bar of claim 17, wherein the first and second illumination elements of each illuminated side are selectively powered dependent upon their orientation relative to a vertical axis corresponding to gravity.

19. An automatic tactical light bar comprises:
a body having a plurality of illuminated sides arranged around a central chamber;
a plurality of illumination elements fixed to the illuminated sides with at least one illumination element per each of the illuminated sides;
an electric circuit in communication with the illumination elements and the central chamber, the circuit including a plurality of orientation sensors;
an electric power source in the central chamber and in communication with the illumination elements through the electric circuit, wherein the number of orientation sensors is less than the number of illuminated sides,
wherein each orientation sensor controls illumination elements corresponding to at least one illuminated side,
wherein each of the orientation sensors are arranged inside the body to selectively supply power to predetermined illumination elements corresponding to the orientation of a first predetermined illuminated side when the body is at rest on a second predetermined illuminated side.

20. The tactical light bar of claim 19, wherein the at least one illumination element of each illuminated side are selectively powered dependent upon their orientation relative to a vertical axis corresponding to gravity.
